(19) United States
(12) Patent Application Publication
(10) Pub. No.: US 2025/0084666 A1
(43) Pub. Date: Mar. 13, 2025

(54) SMALL VOLUME DOOR LOCK PANEL

(71) Applicant: Zhejiang Chaodai Hardware Co., Ltd., Yuhuan (CN)

(72) Inventor: Qiang HUANG, Yuhuan (CN)

(73) Assignee: Zhejiang Chaodai Hardware Co., Ltd., Yuhuan (CN)

(21) Appl. No.: 18/484,642

(22) Filed: Oct. 11, 2023

(30) Foreign Application Priority Data
Sep. 12, 2023 (CN) 202311180413.8

(51) Int. Cl. E05B 9/00; E05B 15/04

(52) U.S. Cl. CPC E05B 9/002; E05B 15/04; E05B 2015/0406

(57) ABSTRACT

A small volume door lock panel includes a panel mounting seat provided with a mounting cavity on one side, and a torsion head provided in the mounting cavity. A fixing member is provided in the mounting cavity. A mounting hole for clamping engagement with a mounting tool is formed in the fixing member. One end of the fixing member is provided with a connection part for connecting and fixing. A safety hole coaxial with and in communication with the mounting hole is formed on the panel mounting seat, a return spring for connecting is provided between the mounting cavity and the torsion head, ends of the return spring are both clamped into the mounting cavity, the torsion head is provided with control parts of a compression spring, and the mounting cavity is provided with a fixed blocking piece which limits the torsion head, the return spring, and the fixing member.

### CROSS-REFERENCE TO RELATED APPLICATIONS

This application claims priority to Chinese Patent Application No. 202311180413.8, filed on Sep. 12, 2023, the content of which is incorporated herein by reference in its entirety.

### TECHNICAL FIELD

The present application belongs to the technical field of locks, and relates to a door lock panel, and particularly to a small volume door lock panel.

### BACKGROUND

A door lock body is usually arranged in a door sheet, door lock panels are arranged on inner and outer surfaces of the door sheet, and the door lock panels are fixed to a door lock mounting seat, such that the door lock is more aesthetic. In addition, for personal privacy and security, a safety device is usually arranged on the door lock, and a safety pin is used to control the activities of the door lock, so as to realize one-way control of the activities of the door lock.

A traditional passage lock panel is fixed to a door lock or door sheet by setting a fixing bolt coaxial with a square shaft, and the exposed fixing bolt enlarges the volume of the door lock panel. Since the fixing bolt is exposed, the clamping part to be docked with the mounting tool is shallow and difficult to operate, and meanwhile, the fixing bolt is coaxial with the square shaft, so when the door lock is to be dismounted, it is necessary to dismount the door handle first, and then use an adapted tool to dock with and dismount the door lock, which leads to a difficult dismounting operation.

### SUMMARY

Aiming at the above-mentioned problems in the prior art, an objective of the present application is to provide a door lock panel with a small volume and a simple and convenient assembly and disassembly.

The objective of the present application is implemented by the following technical solutions: a small volume door lock panel, including a panel mounting seat provided with a mounting cavity on one side, and a torsion head provided in the mounting cavity, where a fixing member is provided in the mounting cavity, a mounting hole for clamping engagement with a mounting tool is formed in the fixing member, and one end of the fixing member is provided with a connection part for connecting and fixing; and where a safety hole coaxial with and in communication with the mounting hole is formed on the panel mounting seat, a return spring for connecting is provided between the mounting cavity and the torsion head, ends of the return spring are both clamped into the mounting cavity, the torsion head is provided with control parts of a compression spring, and the mounting cavity is provided with a fixed blocking piece which limits the torsion head, the return spring, and the fixing member.

In the above-mentioned small volume door lock panel, an indexing portion for guiding the rotation of the torsion head is provided in the mounting cavity, a plurality of spring limiting portions protrude from the indexing portion, both ends of the return spring are provided with a clamping end clamped in the spring limiting portion; the torsion head is provided with a plurality of control parts for pressing the clamping ends, and a square hole for clamping a square core of a door lock is formed in the center of the torsion head.

In the above-mentioned small volume door lock panel, the compression spring is located between the fixing member and the panel mounting seat.

In the above-mentioned small volume door lock panel, the connection part is connection threads.

In the above-mentioned small volume door lock panel, a clamping hole for mounting a mounting member is formed on the fixed blocking piece.

In the above-mentioned small volume door lock panel, the mounting cavity is provided with a plurality of locking screws for fixing the mounting seat.

In the above-mentioned small volume door lock panel, the mounting hole is a hexagonal hole.

Compared with the prior art, the novel door lock panel according to the present application reduces the protruding portions of the panel by providing the fixing member in communication with the safety hole in the mounting cavity, and keeps the panel integrated by fixing the return spring, the torsion head, and the fixing member in the cavity with the fixed blocking piece, such that the assembly and disassembly of the panel are simpler and more convenient, and the hexagonal mounting hole can be used for mounting the safety pin, which enables the assembly and disassembly to be simpler and more convenient without the need to use a special tool during the assembly and disassembly.

### BRIEF DESCRIPTION OF THE DRAWINGS

FIG. 1 is a schematic view of a structure of a small volume door lock panel according to the present application.

FIG. 2 is a schematic half-sectional view of a small volume door lock panel according to the present application.

FIG. 3 is a schematic view of a structure of a small volume door lock panel according to the present application.

FIG. 4 is a schematic view showing structures of a torsion head and a fixed blocking piece of a small volume door lock panel according to the present application.

### DETAILED DESCRIPTION OF THE EMBODIMENTS

The technical solutions of the present application are further described below with reference to the specific embodiments of the present application and in conjunction with the accompanying drawings, however, the present application is not limited to these embodiments.

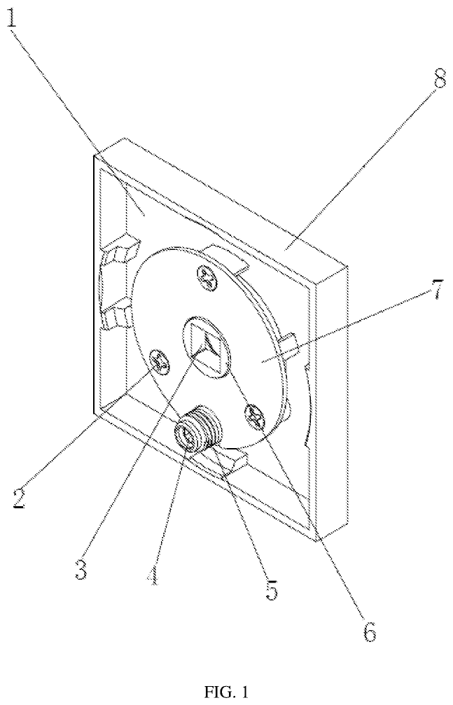

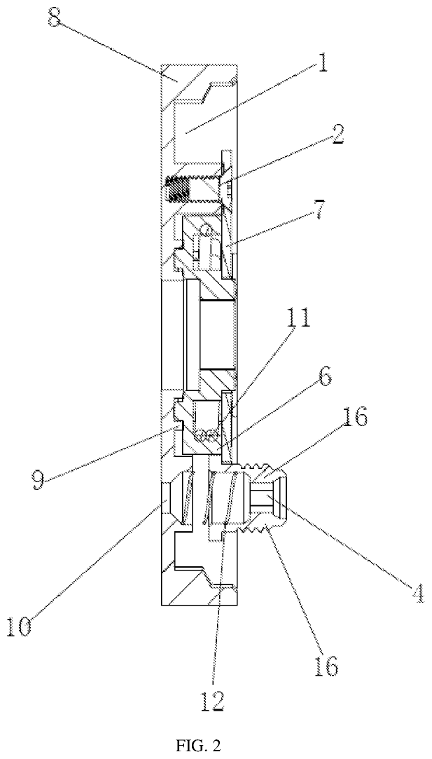

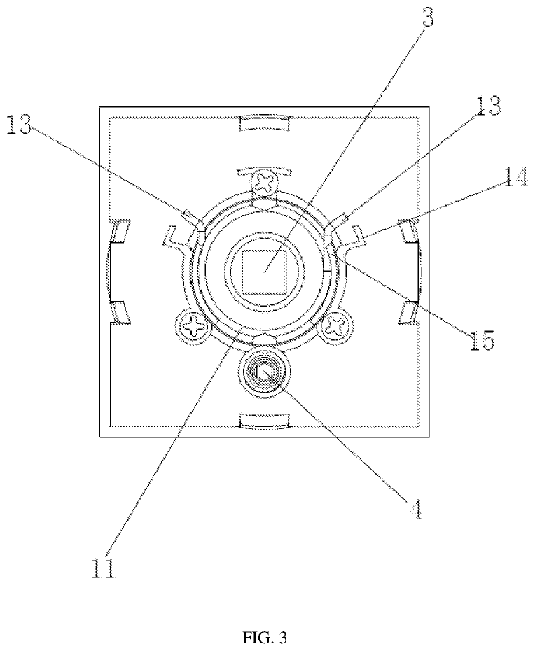

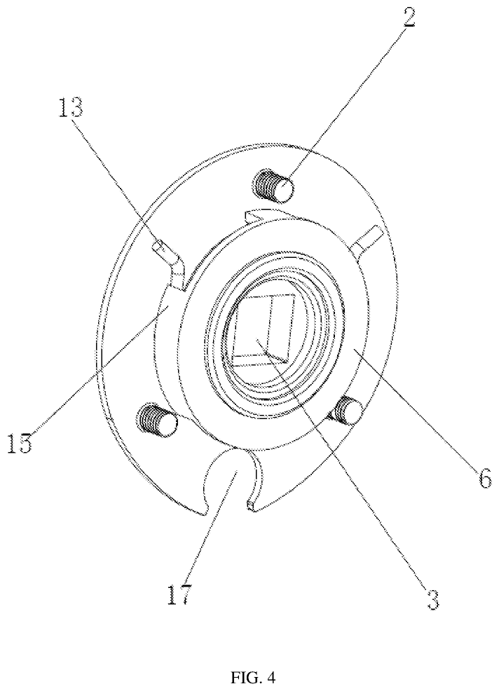

As shown in FIGS. 1, 2, 3, and 4, the small volume door lock panel according to the present application includes a panel mounting seat 8 provided with a mounting cavity 1 on one side, and a torsion head 6 provided in the mounting cavity 1, where a fixing member 16 is provided in the mounting cavity 1, a mounting hole 4 for clamping engagement with a mounting tool is formed in the fixing member 16, and one end of the fixing member 16 is provided with a connection part for connecting and fixing; and where a safety hole 10 coaxial with and in communication with the mounting hole 4 is formed on the panel mounting seat 8, a return spring 11 for connecting is provided between the mounting cavity 1 and the torsion head 6, ends of the return spring 11 are both clamped into the mounting cavity 1, the torsion head 6 is provided with control parts 15 of a compression spring 12, and the mounting cavity 1 is provided with a fixed blocking piece 7 which limits the torsion head 6, the return spring 11, and the fixing member 16. During assembly, the torsion head 6, the return spring 11, and a mounting member are first mounted in the mounting cavity 1 in sequence, and then fixed into a unibody through the fixed blocking piece 7, which not only reduces the panel volume but also enables the assembly and disassembly of the door lock panel to be simpler and more convenient. The safety hole 10 arranged coaxially with the mounting hole 4 enables the mounting of the safety pin to be simpler and more convenient. During disassembly, the safety pin is removed, and the door lock panel is disengaged and removed from the door lock by rotating the fixing member 16.

Preferably, an indexing portion 9 for guiding the rotation of the torsion head 6 is provided in the mounting cavity 1, a plurality of spring limiting portions 14 protrude from the indexing portion 9, both ends of the return spring 11 are provided with a clamping end 13 clamped in the spring limiting portion 14; the torsion head 6 is provided with a plurality of control parts 15 for pressing the clamping ends 13, and a square hole 3 for clamping a square core of a door lock is formed in the center of the torsion head. The spring is compressed and the door lock is controlled to be opened when the door handle is rotated, and the door handle is reset under the action of the spring after the door handle is released.

Preferably, the compression spring 12 is located between the fixing member 16 and the panel mounting seat 8, and the compression spring 12 enables the fixing member 16 to abut against the fixed blocking piece 7, so as to prevent the fixing member 16 from being displaced when being mounted, thereby enabling the mounting of the fixing member 16 simpler and more convenient.

Preferably, the connection part is connection threads 5, and the door lock panel according to the present application can be fixed to a door sheet through the connection threads 5, or fixed to a door lock safety device through the connection threads 5, such that the mounting hole 4 and the safety device remain coaxial.

Preferably, the mounting cavity 1 is provided with a plurality of locking screws 2 for fixing the mounting seat.

Preferably, a clamping hole 17 for mounting a mounting member is formed on the fixed blocking piece 7.

Preferably, the mounting hole 4 is a hexagonal hole.

The specific embodiments described herein are merely illustrative examples of the spirit of the present application. Various modifications or supplements can be made to the specific embodiments described herein or substitutions can be adopted in a similar manner by those skilled in the art without departing from the spirit of the present application or exceeding the scope defined by the appended claims.

Although terms such as the mounting cavity 1, the locking screw 2, the square hole 3, the mounting hole 4, the connection thread 5, the torsion head 6, the fixed blocking piece 7, the panel mounting seat 8, the indexing portion 9, the safety hole 10, the return spring 11, the compression spring 12, the clamping end 13, the spring limiting portion 14, the control part 15, the fixing member 16, and the clamping hole 17 and the like are frequently used herein, it is possible to use other terms. These terms are used merely to more conveniently describe and explain the essence of the present application, and it is contrary to the spirit of the present application to construe them as any additional limitations.

What is claimed is:

1. A small volume door lock panel, comprising a panel mounting seat provided with a mounting cavity on one side, and a torsion head provided in the mounting cavity, wherein
a fixing member is provided in the mounting cavity, a mounting hole for clamping engagement with a mounting tool is formed in the fixing member, and one end of the fixing member is provided with a connection part for connecting and fixing; and
a safety hole coaxial with and in communication with the mounting hole is formed on the panel mounting seat, a return spring for connecting is provided between the mounting cavity and the torsion head, ends of the return spring are both clamped into the mounting cavity, the torsion head is provided with control parts of a compression spring, and the mounting cavity is provided with a fixed blocking piece which limits the torsion head, the return spring, and the fixing member.

2. The small volume door lock panel according to claim 1, wherein an indexing portion for guiding the rotation of the torsion head is provided in the mounting cavity, a plurality of spring limiting portions protrude from the indexing portion, both ends of the return spring are provided with a clamping end clamped in the spring limiting portion; the torsion head is provided with a plurality of control parts for pressing the clamping ends, and a square hole for clamping a square core of a door lock is formed in the center of the torsion head.

3. The small volume door lock panel according to claim 1, wherein the compression spring is located between the fixing member and the panel mounting seat.

4. The small volume door lock panel according to claim 1, wherein the connection part is connection threads.

5. The small volume door lock panel according to claim 1, wherein a clamping hole for mounting a mounting member is formed on the fixed blocking piece.

6. The small volume door lock panel according to claim 1, wherein the mounting cavity is provided with a plurality of locking screws for fixing the mounting seat.

7. The small volume door lock panel according to claim 1, wherein the mounting hole is a hexagonal hole.
